(19) United States
(12) Patent Application Publication
(10) Pub. No.: US 2003/0097747 A1
(43) Pub. Date: May 29, 2003

(54) Method of machining a part

(76) Inventor: Michael A. Kopmanis, Carleton, MI (US)

Correspondence Address: Steven L. Oberholtzer, BRINKS HOFER GILSON & LIONE, P.O. Box 10395, Chicago, IL, 60610, US

(21) Appl. No.: 09/997,055

(22) Filed: Nov. 29, 2001

(51) Int. Cl. B23P 13/00

(52) U.S. Cl. 29/558

(57) ABSTRACT

A method of machining a part including clamping the part on a chuck, while the part is clamped on the chuck, orienting the part with an OD-type grinding tool and grinding a ball track on the part, and while the part is still clamped on the chuck, orienting the part with a cutting tool and cutting an outer surface of the part.

### TECHNICAL FIELD

This invention relates generally to the machining field, and more specifically to an improved method of machining a part of an automobile.

### BACKGROUND OF THE INVENTION

The machining of an inner race for a constant-velocity joint of an automobile is a complex process. The complex process typically includes ID-type grinding of the ball tracks, multiple clamping of the part into one or more chucks, or both. These aspects of the conventional methods are inefficient in terms of tooling cost, machining time, and overall complexity. Thus, there is a need in the machining field to create an improved method of machining a part. This invention provides such improved method.

### BRIEF DESCRIPTION OF THE DRAWINGS

FIG. 1 is a top view of a finished product machined with the preferred method of the invention;

FIG. 2 is a perspective view of the finished product of FIG. 1;

FIG. 3 is a cross-sectional view of the specialized chuck used with the preferred method of the invention;

FIGS. 4 and 5 are side and top views, respectively, of the grinding process of the preferred method of the invention; and

FIGS. 6 and 7 are side and top views, respectively, of the cutting process of the preferred method of the invention.

### DESCRIPTION OF THE PREFERRED METHOD OF THE INVENTION

The following description of the preferred method of the invention is not intended to limit the invention to this preferred method, but rather to enable any person skilled in the machining art to use this invention.

As shown in the FIGURES, the preferred method of the invention includes clamping a part 10 on a chuck 12, orienting the part 10 with an OD-type grinding tool 14 and grinding a ball track 16 on the part 10 while the part 10 is clamped on the chuck 12, and orienting the part 10 with a cutting tool 18 and cutting an outer surface 20 of the part 10 while the part 10 is still clamped on the chuck 12. The preferred method has been specifically designed to machine an inner race 10 for a constant-velocity joint having six ground ball tracks 16 and a smooth cut outer surface 20. The preferred method, however, may be used, with or without additional steps, to machine any suitable part for any suitable environment having at least one ground ball track 16 and a cut outer surface 20.

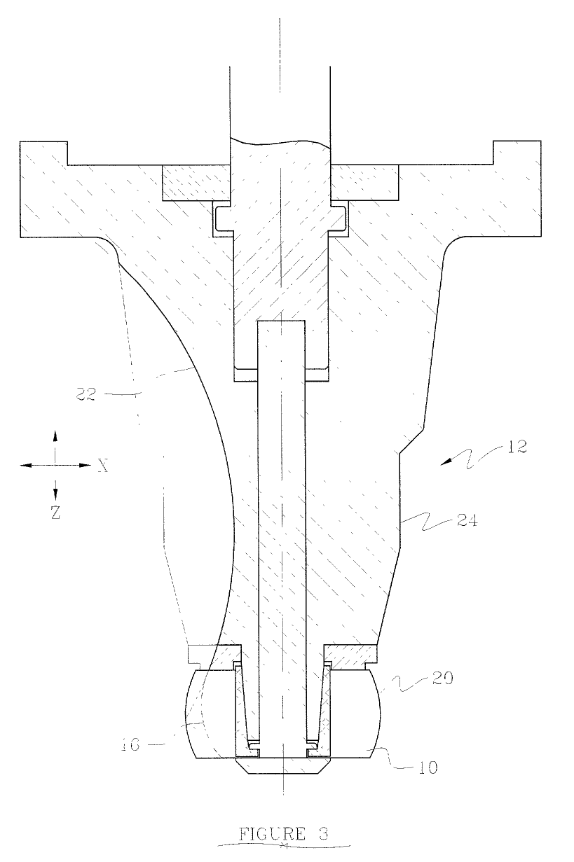

As shown in FIG. 3, clamping the part 10 on a chuck 12 includes the use of a specialized chuck 12. The specialized chuck 12 functions to retain the part 10 during the grinding of the ball track 16 and to turn the part 10 against the cutting tool during the cutting of the outer surface 20. To accomplish both functions, the specialized chuck 12 includes six deep recesses 22 (one shown), which receive the OD-type grinding tool during the grinding of the ball track 16, and six structural portions 24 (one shown), which support the part 10 during the grinding of the ball track 16 and during the cutting of the outer surface 20. The specialized chuck 12 is preferably made from a conventional rigid material, such as steel, and with conventional forging and machining methods, but may alternatively be made from other suitable materials and with other suitable methods.

The specialized chuck 12 is preferably mounted to a machine for movement along an X axis and a Z axis. One of the features of the preferred method includes limiting the movements of the components of the chuck 12 to those movements along the X axis and Z axis. Although most likely incurring greater cost, greater complexity, and greater inaccuracy, the machine may be modified to allow movements of the chuck 12 along other axes.

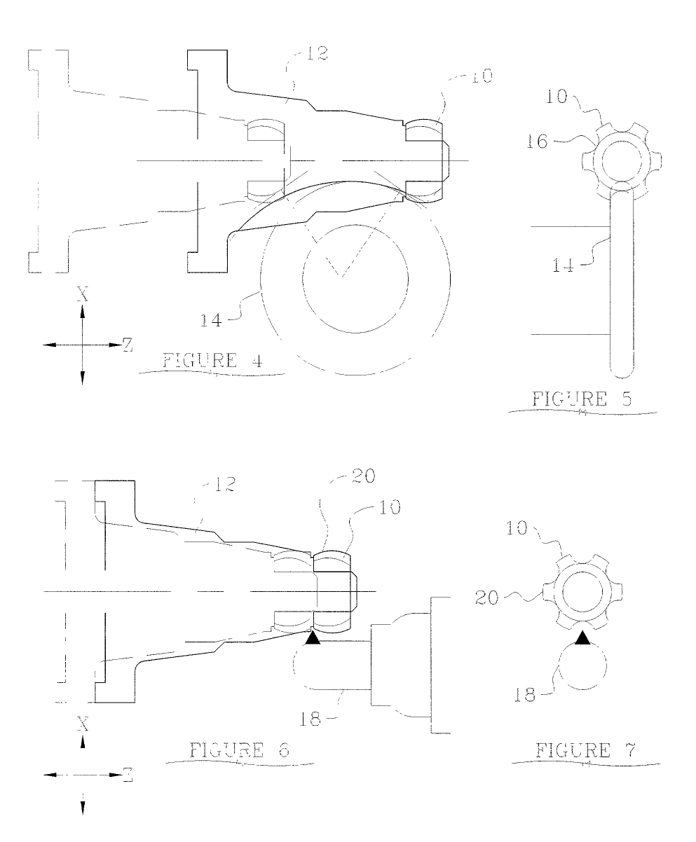

In the preferred method, after the part 10 is clamped on the chuck 12, the chuck 12 moves the part 10 toward the grinding tool 14 and orientates the part 10 with the grinding tool 14 for the grinding of a particular ball track 16, as shown in FIGS. 4 and 5. Moving the part 10 towards the grinding tool 14 preferably involves moving the part 10 a short distance along the X axis and Z axis. Orienting the part 10 with the grinding tool 14 preferably includes rotating the part 10 until a particular location of the part 10 is oriented with the grinding tool 14.

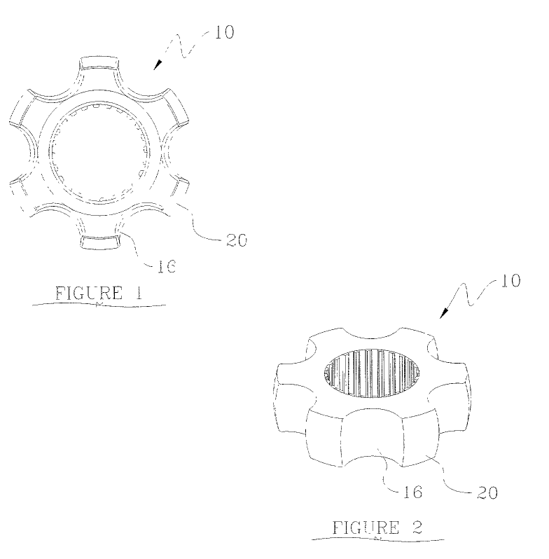

Grinding the ball track 16 on the part 10 includes spinning the OD-type grinding tool 14 and moving the part 10 against the grinding tool 14. As shown in FIGS. 1 and 2, the ball track 16 of the part 10 preferably has a complex curvature including a concave curve along a plane defined by the X and Y axis and a convex curve along the Z axis. Although the concave curve is preferably machined by a simple rotation of the profile of the OD-type grinding tool 14, the convex curve is preferably accomplished by an arcuate movement of the part 10 relative the grinding tool 14. The chuck 12 preferably accomplishes this actuate movement by moving the part 10 along the X axis and Z axis against the grinding tool 14, as shown in FIGS. 4 and 5.

The grinding tool 14 used in the preferred method is typically known as an OD-type grinding tool 14, which spins along an axis generally perpendicular to the rotational axis of the part 10. The grinding tool 14 of conventional methods, in contrast, is an ID-type grinding tool, which generally spins long an axis parallel with the rotational axis of a part at a much higher speed than the OD-type grinding tool. For this reason, the specialized chuck 12 preferably includes the deep recesses to “swallow” the grinding tool 14.

The grinding of the ball track 16 is preferably accomplished after the part 10 has been hardened. In this manner, the grinding is typically known as hard grinding. Because the part has already been hardened, the hard grinding of the ball track 16 may be performed to the exact specifications for the final product. The grinding, of course, may be performed on an unhardened part 10.

In the preferred method of the invention, after the ball track 16 has been ground on the part 10, the acts of orienting the part 10 with the grinding tool 14 and grinding the ball track 16 is repeated to produce the final product with six ball tracks 16. The orienting of the part 10 with the grinding tool 14 in the subsequent acts includes rotating the part 10 relative the grinding tool 14 to the location of the next ball track 16.

After the grinding of the ball tracks 16, the part 10 is preferably oriented with the cutting tool 18 while the part 10 is still clamped on the chuck 12, as shown in FIGS. 6 and 7. Orienting the part 10 with the cutting tool 18 preferably includes moving the part 10 towards the cutting tool 18 along the X axis and Z axis, which is preferably located in another section of the machine.

The cutting of the outer surface preferably includes the part 10 against the cutting tool 18. As shown in FIGS. 2 and 3, the outer surface 20 of the part 10 preferably has a convex curvature along the Z axis. For this reason, the chuck 12 preferably moves the part 10 against the cutting toll 18 along the X axis and Z axis during the cutting of the outer surface 20, as shown in FIGS. 6 and 7. The chuck 12 is preferably limited to only move the part 10 along the Z axis and X axis, and to hold the cutting tool 18 stationary. These limitations preferably reduce the complexity of the machine. The machine may, however, be modified to allow movements of the chuck 12 along other axes.

The cutting of the outer surface 20 is preferably accomplished after the grinding of the ball tracks 16 and after the hardening of the part 10. In this manner, the cutting of the outer surface 20 is typically known as hard cutting, or hard turning. The cutting of the outer surface 20 may be accomplished before the grinding of the ball tracks 16 or before the hardening of the part 10. In this alternative method, however, the cutting of the outer surface 20 and the grinding of the ball tracks 16 are still preferably accomplished with a single clamping of the part 10 on the specialized chuck 12.

After the ball tracks 16 have been ground and the outer surface 20 has been cut, the finished product is finally removed from the specialized chuck 12. The removal of the part 10 from the chuck 12 preferably occurs after the grinding of the ball tracks 16 and the cutting of the outer surface 20 such that the machining of the part 10 is accomplished with a single clamping of the part 10 to the chuck 12. The single clamping of the part 10 on the chuck 12, which is another feature of the preferred of the invention, reduces the complexity of the control system for the machine, reduces the time to machine the part 10, and increases the accuracy of the final product.

As any person skilled in the art of machining will recognize from the previous description and from the figures and claims, modifications and changes can be made to the preferred method of the invention without departing from the scope of this invention defined in the following claims.

I claim:

1. A method of machining a part comprising:
clamping the part on a chuck;
while the part is clamped on the chuck, orienting the part with an OD-type grinding tool and grinding a ball track on the part; and
while the part is still clamped on the chuck, orienting the part with a cutting tool and cutting an outer surface of the part.

2. The method of machining a part of claim 1, wherein said orienting the part with a grinding tool includes moving the part towards the grinding tool.

3. The method of machining a part of claim 2, wherein said grinding a ball track includes spinning the grinding tool.

4. The method of machining a part of claim 3, wherein said grinding a ball tack includes moving the part along an X axis and a Z axis against the grinding tool.

5. The method of machining a part of claim 1, wherein said grinding a ball track includes hard grinding.

6. The method of machining a part of claim 1, further comprising the repetition of said orienting the part with a grinding tool and said grinding a ball track to produce a part with six ball tracks.

7. The method of machining a part of claim 1, wherein said orienting the part with a cutting tool includes moving the part towards the cutting tool.

8. The method of machining a part of claim 7, wherein said cutting includes turning the part against the cutting tool.

9. The method of machining a part of claim 8, wherein said cutting an outer surface includes moving the part along an X axis and Z axis against the cutting tool.

10. The method of machining a part of claim 1, wherein cutting an outer surface includes hard cutting.

11. The method of machining a part of claim 1, wherein said grinding a ball track occurs before said cutting an outer surface.

12. The method of machining a part of claim 1, further comprising removing the part from the chuck.
